(19) United States
(12) Patent Application Publication
(10) Pub. No.: US 2025/0053983 A1
(43) Pub. Date: Feb. 13, 2025

(54) SYSTEMS AND METHODS FOR INCREASING SECURITY FOR DIGITAL TRANSACTIONS WITH PREDETERMINED RISK FACTORS

(71) Applicant: Capital One Services, LLC, McLean, VA (US)

(72) Inventors: Daniel Pick, Falls Church, VA (US); Jayanth Prathipati, Aldie, VA (US); Colin Hart, Falls Church, VA (US)

(73) Assignee: Capital One Services, LLC, McLean, VA (US)

(21) Appl. No.: 18/232,541

(22) Filed: Aug. 10, 2023

(51) Int. Cl. G06Q 20/40; G06Q 20/34

(52) U.S. Cl. CPC G06Q 20/4016; G06Q 20/352

(57) ABSTRACT

Systems and methods disclosed herein can determine when a digital transaction initiated in connection with a user account satisfies at least one predetermined risk factor. Responsive thereto, systems and methods disclosed herein can increase security to verify that the digital transaction is likely being initiated by an authorized user of the user account prior to executing the digital transaction in connection with the user account. To do so, a mobile device can communicate with a contactless card to receive a cryptogram therefrom, verify the cryptogram to identify the user account and to confirm that the contactless card is associated with the user account, and verify that a phone number of the mobile device is also associated with the user account.

### BACKGROUND

Customers routinely initiate digital transactions, such as wire transfers, from Internet browsers on a desktop computer or a mobile device and from mobile applications on the mobile device. Some security measures, such as user names and passwords, are routinely implemented to ensure that only authorized users are initiating these digital transactions. However, some digital transactions are inherently more risky, prone to fraud, or associated with bad actors.

### BRIEF SUMMARY

In some embodiments, a method can include soliciting communication between a contactless card and a mobile device when a digital transaction initiated in connection with a user account satisfies at least one predetermined risk factor, receiving, by a short-range communication antenna of the mobile device, a cryptogram from the contactless card, verifying, by a processor of the mobile device, the cryptogram to identify the user account and to confirm that the contactless card is associated with the user account, verifying, by the processor of the mobile device, that a phone number of the mobile device is associated with the user account, and when the contactless card and the phone number of the mobile device are associated with the user account, authorizing execution of the digital transaction in connection with the user account.

In some embodiments, the digital transaction can include a wire transfer. In some embodiments, the at least one predetermined risk factor can include the digital transaction being valued at a predetermined amount of currency or higher. In some embodiments, the at least one predetermined risk factor can include the digital transaction originating from a suspicious location, a suspicious device, or a suspicious Internet Protocol (IP) address.

In some embodiments, the method can include successfully decrypting the cryptogram to verify the cryptogram and to identify the user account. In some embodiments, the method can include decrypting protected data in the cryptogram, comparing the protected data to stored record data associated with the contactless card, and identifying the user account based on a match between the protected data and the stored record data.

In some embodiments, the method can include transmitting the cryptogram from the mobile device to a server and receiving, at the mobile device, one or more indications that the cryptogram and the phone number of the mobile device have been verified. In some embodiments, the method can include transmitting one or more messages from the mobile device to the server.

In some embodiments, a non-transitory computer-readable medium can include instructions that, when executed by a processor, cause the processor to solicit communication between a contactless card and a mobile device when a digital transaction initiated in connection with a user account satisfies at least one predetermined risk factor, receive, via a short-range communication antenna of the mobile device, a cryptogram from the contactless card, verify the cryptogram to identify the user account and to confirm that the contactless card is associated with the user account, verify that a phone number of the mobile device is associated with the user account, and when the contactless card and the phone number of the mobile device are associated with the user account, authorize execution of the digital transaction in connection with the user account.

In some embodiments, the digital transaction can include a wire transfer. In some embodiments, the at least one predetermined risk factor can include the digital transaction being valued at a predetermined amount of currency or higher. In some embodiments, the at least one predetermined risk factor can include the digital transaction originating from a suspicious location, a suspicious device, or a suspicious IP address.

In some embodiments, the instructions can further cause the processor to successfully decrypt the cryptogram to verify the cryptogram and to identify the user account. In some embodiments, the instructions can further cause the processor to decrypt protected data in the cryptogram, compare the protected data to stored record data associated with the contactless card, and identify the user account based on a match between the protected data and the stored record data.

In some embodiments, the instructions can further cause the processor to transmit the cryptogram to a server and receive one or more indications that the cryptogram and the phone number of the mobile device have been verified. In some embodiments, the instructions can further cause the processor to transmit one or more messages to the server.

In some embodiments, a mobile device can include a short-range communication antenna, a processor, and a memory storing instructions that, when executed by the processor, cause the processor to solicit communication with a contactless card when a digital transaction initiated in connection with a user account satisfies at least one predetermined risk factor, receive, via the short-range communication antenna, a cryptogram from the contactless card, verify the cryptogram to identify the user account and to confirm that the contactless card is associated with the user account, verify that a phone number of the mobile device is associated with the user account, and when the contactless card and the phone number of the mobile device are associated with the user account, authorize execution of the digital transaction in connection with the user account.

In some embodiments, the mobile device can include a user interface device, and the instructions can further cause the processor to display on or emit from the user interface device a solicitation for the communication with the contactless card.

In some embodiments, the mobile device can include an Internet browser or a mobile application, and the digital transaction can be initiated via the Internet browser or the mobile application.

In some embodiments, the digital transaction can be initiated via an Internet browser on a desktop computer.

Other technical features may be readily apparent to one skilled in the art from the following figures, descriptions, and claims.

### BRIEF DESCRIPTION OF THE SEVERAL VIEWS OF THE DRAWINGS

FIG. 1 illustrates an example of a system in accordance with one embodiment.

FIG. 2 illustrates an example of a system in accordance with one embodiment.

FIG. 3 illustrates an example of a contactless card in accordance with one embodiment.

FIG. 4 illustrates an example of a transaction card component in accordance with one embodiment.

FIG. 5 illustrates an example of a sequence flow in accordance with one embodiment.

FIG. 6 illustrates an example of a data structure in accordance with one embodiment.

FIG. 7 illustrates an example of a key system in accordance with one embodiment.

FIG. 8 illustrates an example of a method of generating a cryptogram in accordance with one embodiment.

FIG. 9 illustrates an example of a method of key diversification in accordance with one embodiment.

FIG. 10 illustrates an example of a method of card activation in accordance with one embodiment.

FIG. 11 illustrates an example of a mobile device in accordance with one embodiment.

FIG. 12 illustrates an example of a system in accordance with one embodiment.

FIG. 13 illustrates an example of a method in accordance with one embodiment.

FIG. 14 illustrates an example of a sequence flow in accordance with one embodiment.

FIG. 15 illustrates an example of a computer architecture in accordance with one embodiment.

FIG. 16 illustrates an example of a communications architecture in accordance with one embodiment.

### DETAILED DESCRIPTION

Embodiments disclosed herein are generally directed to systems and methods for increasing security for digital transactions with predetermined risk factors. For example, in some embodiments, systems and methods disclosed herein can determine when a digital transaction initiated in connection with a user account satisfies at least one predetermined risk factor. In these instances, instead of simply executing the digital transaction, systems and methods disclosed herein can increase security to verify that the digital transaction is likely being initiated by an authorized user of the user account prior to executing the digital transaction in connection with the user account.

It is to be understood that the digital transaction can include any transaction that takes place beginning to end without any need for cash or paper. For example, in some embodiments, the digital transaction can include a wire transfer. Additionally or alternatively, the digital transfer can include any exchange of goods or services, both electronically, such as on the internet, and in person. Additionally or alternatively, in some embodiments, the digital transaction can include access to a secure item or location (e.g., a lockbox, a safe, or access-restricted area). In any embodiment, the digital transaction can include any type of interchange or interaction where a sliding scale of security is desired.

In some embodiments, the at least one predetermined risk factor can include the digital transaction being valued at a predetermined amount of currency or higher. Additionally or alternatively, in some embodiments, the at least one predetermined risk factor can include the digital transaction originating from a suspicious location, such as within or outside of a designated country. Additionally or alternatively, in some embodiments, the at least one predetermined risk factor can include the digital transaction originating from a suspicious device or a suspicious IP address, such as an unknown device or IP address or one known to cause fraud.

In any embodiment, when the digital transaction initiated in connection with the user account satisfies the at least one predetermined risk factor, systems and methods disclosed herein can solicit communication between a contactless card and a mobile device. Then, a short-range communication antenna of the mobile device can receive a cryptogram from the contactless card, and a processor of the mobile device can verify the cryptogram to identify the user account and to confirm that the contactless card is associated with the user account. In some embodiments, the processor of the mobile device can also verify that a phone number of the mobile device is associated with the user account. When both of these conditions are satisfied, that is, the contactless card and the phone number of the mobile device are confirmed and verified to be associated with the user account, systems and methods disclosed herein can authorize execution of the digital transaction in connection with the user account.

In some embodiments, the processor of the mobile device can successfully decrypt the cryptogram to verify the cryptogram and to identify the user account. For example, in some embodiments, the processor of the mobile device can decrypt protected data in the cryptogram, compare the protected data to stored record data on file in the database for the user account, and identify the user account based on a match between the protected data and the stored record data.

Additionally or alternatively, in some embodiments, the mobile device can transmit one or more messages that include the cryptogram to a server in communication with the mobile device, and the server can successfully decrypt the cryptogram to verify the cryptogram and to identify the user account. The server can also verify that the phone number of the mobile device is associated with the user account. As such, the mobile device can receive one or more indication messages from the server that the cryptogram and/or the phone number of the mobile device have been verified.

Advantageously, systems and methods disclosed herein can provide for enhanced security for certain digital transactions. Indeed, when a digital transaction is identified as inherently risk due to satisfying one or more risk factors, systems and methods disclosed herein can verify that the digital transaction is likely being initiated by an authorized user of the user account. In this regard, any digital transaction initiated by a bad actor in connection with the user account will not be executed unless the bad actor possesses the contactless card associated with the user account. Moreover, even if the bad actor has possession of the contactless card associated with the user account, the digital transaction still will not be executed unless the bad actor also possesses the mobile device with the phone number associated with the user account, which is not likely.

Details of the above-identified embodiments and additional advantages thereof are discussed in the following description.

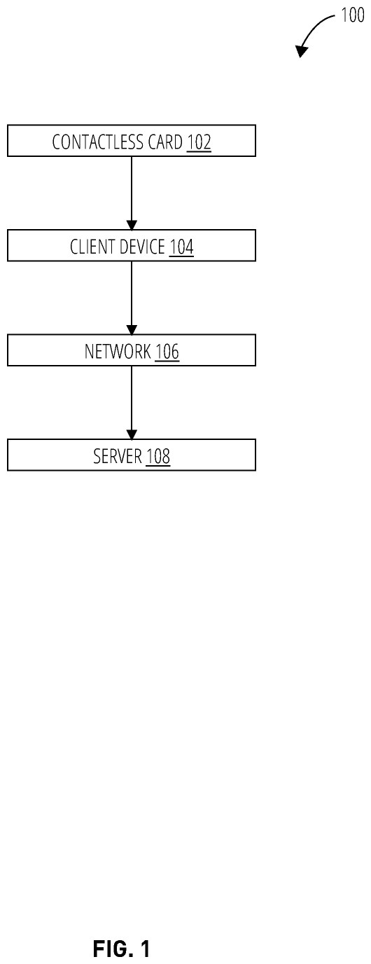

FIG. 1 illustrates a data transmission system 100 according to an example embodiment. As further discussed below, system 100 may include contactless card 102, client device 104, network 106, and server 108. Although FIG. 1 illustrates single instances of the components, system 100 may include any number of components.

System 100 may include one or more contactless cards 102, which are further explained below. In some embodiments, contactless card 102 may be in wireless communication, utilizing Near-Field Communication (NFC) in an example, with client device 104.

System 100 may include client device 104, which may be a network-enabled computer. As referred to herein, a network-enabled computer may include, but is not limited to a computer device, or communications device including, e.g., a server, a network appliance, a personal computer, a workstation, a phone, a handheld personal computer (PC), a personal digital assistant, a thin client, a fat client, an Internet browser, or other device. Client device 104 also may be a mobile device; for example, a mobile device may include an iPhone, iPod, iPad from Apple® or any other mobile device running Apple's iOS® operating system, any device running Microsoft's Windows® mobile operating system, any device running Google's Android® operating system, and/or any other smartphone, tablet, or like wearable mobile device.

The client device 104 device can include a processor and a memory, and it is understood that the processing circuitry may contain additional components, including processors, memories, error and parity/cyclic redundance check (CRC) checkers, data encoders, anticollision algorithms, controllers, command decoders, security primitives and tamperproofing hardware, as necessary to perform the functions described herein. The client device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, client device 104 of system 100 may execute one or more applications, such as software applications, that enable, for example, network communications with one or more components of system 100 and transmit and/or receive data.

The client device 104 may be in communication with one or more server(s) 108 via one or more network(s) 106, and may operate as a respective front-end to back-end pair with server 108. The client device 104 may transmit, for example from a mobile device application executing on client device 104, one or more requests to server 108. The one or more requests may be associated with retrieving data from server 108. The server 108 may receive the one or more requests from client device 104. Based on the one or more requests from client device 104, server 108 may be configured to retrieve the requested data from one or more databases (not shown). Based on receipt of the requested data from the one or more databases, server 108 may be configured to transmit the received data to client device 104, the received data being responsive to one or more requests.

System 100 may include one or more networks 106. In some examples, network 106 may be one or more of a wireless network, a wired network or any combination of wireless network and wired network, and may be configured to connect client device 104 to server 108. For example, network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, Digital Advanced Mobile Phone System (D-AMPS), Wi-Fi, Fixed Wireless Data, Institute of Electrical and Electronics Engineers (IEEE) 802.11 family of networking, Bluetooth, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof. network 106 may further include one network, or any number of the exemplary types of networks mentioned above, operating as a stand-alone network or in cooperation with each other. Network 106 may utilize one or more protocols of one or more network elements to which they are communicatively coupled. Network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

System 100 may include one or more servers 108. In some examples, server 108 may include one or more processors, which are coupled to memory. The server 108 may be configured as a central system, server or platform to control and call various data at different times to execute a plurality of workflow actions. Server 108 may be configured to connect to the one or more databases. The server 108 may be connected to at least one client device 104.

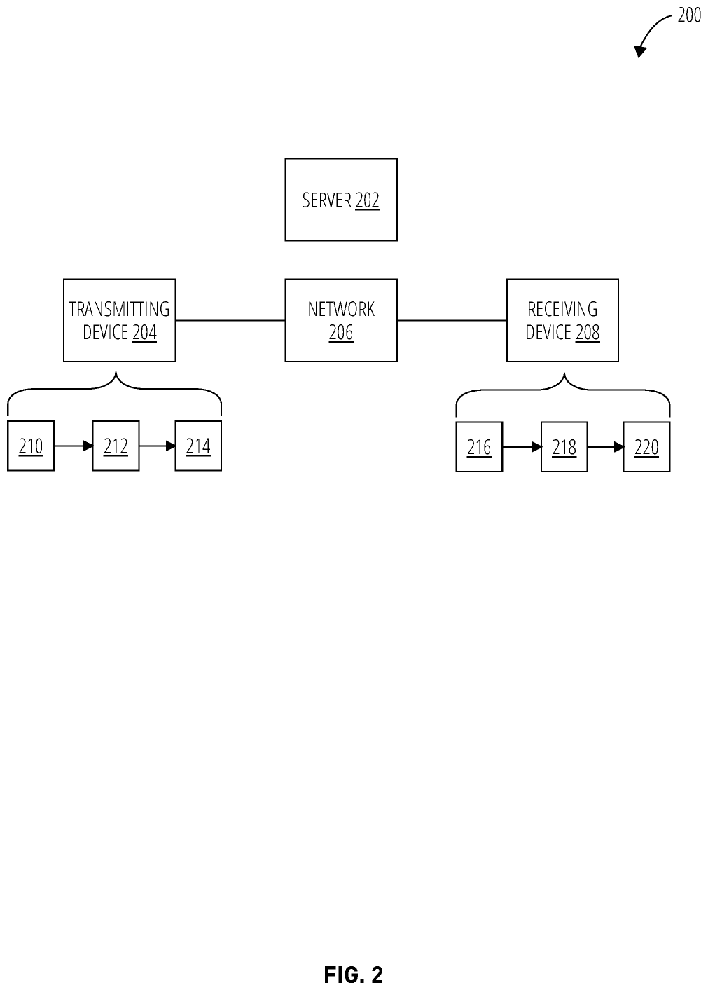

FIG. 2 illustrates a data transmission system according to an example embodiment. System 200 may include a transmitting or transmitting device 204, a receiving or receiving device 208 in communication, for example via network 206, with one or more servers 202. Transmitting or transmitting device 204 may be the same as, or similar to, client device 104 discussed above with reference to FIG. 1. Receiving or receiving device 208 may be the same as, or similar to, client device 104 discussed above with reference to FIG. 1. Network 206 may be similar to network 106 discussed above with reference to FIG. 1. Server 202 may be similar to server 108 discussed above with reference to FIG. 1. Although FIG. 2 shows single instances of components of system 200, system 200 may include any number of the illustrated components.

When using symmetric cryptographic algorithms, such as encryption algorithms, hash-based message authentication code (HMAC) algorithms, and cipher-based message authentication code (CMAC) algorithms, it is important that the key remain secret between the party that originally processes the data that is protected using a symmetric algorithm and the key, and the party who receives and processes the data using the same cryptographic algorithm and the same key.

It is also important that the same key is not used too many times. If a key is used or reused too frequently, that key may be compromised. Each time the key is used, it provides an attacker an additional sample of data which was processed by the cryptographic algorithm using the same key. The more data which the attacker has which was processed with the same key, the greater the likelihood that the attacker may discover the value of the key. A key used frequently may be comprised in a variety of different attacks.

Moreover, each time a symmetric cryptographic algorithm is executed, it may reveal information, such as side-channel data, about the key used during the symmetric cryptographic operation. Side-channel data may include minute power fluctuations which occur as the cryptographic algorithm executes while using the key. Sufficient measurements may be taken of the side-channel data to reveal enough information about the key to allow it to be recovered by the attacker. Using the same key for exchanging data would repeatedly reveal data processed by the same key.

However, by limiting the number of times a particular key will be used, the amount of side-channel data which the attacker is able to gather is limited and thereby reduces exposure to this and other types of attack. As further described herein, the parties involved in the exchange of cryptographic information (e.g., sender and recipient) can independently generate keys from an initial shared master symmetric key in combination with a counter value, and thereby periodically replace the shared symmetric key being used without needing to resort to any form of key exchange to keep the parties in sync. By periodically changing the shared secret symmetric key used by the sender and the recipient, the attacks described above are rendered impossible.

Referring back to FIG. 2, system 200 may be configured to implement key diversification. For example, a sender and recipient may desire to exchange data (e.g., original sensitive data) via respective devices 204 and 208. As explained above, although single instances of transmitting device 204 and receiving device 208 may be included, it is understood that one or more transmitting devices 204 and one or more receiving devices 208 may be involved so long as each party shares the same shared secret symmetric key. In some examples, the transmitting device 204 and receiving device 208 may be provisioned with the same master symmetric key. Further, it is understood that any party or device holding the same secret symmetric key may perform the functions of the transmitting device 204 and similarly any party holding the same secret symmetric key may perform the functions of the receiving device 208. In some examples, the symmetric key may comprise the shared secret symmetric key which is kept secret from all parties other than the transmitting device 204 and the receiving device 208 involved in exchanging the secure data. It is further understood that both the transmitting device 204 and receiving device 208 may be provided with the same master symmetric key, and further that part of the data exchanged between the transmitting device 204 and receiving device 208 comprises at least a portion of data which may be referred to as the counter value. The counter value may comprise a number that changes each time data is exchanged between the transmitting device 204 and the receiving device 208.

System 200 may include one or more networks 206. In some examples, network 206 may be one or more of a wireless network, a wired network or any combination of wireless network and wired network, and may be configured to connect one or more transmitting devices 204 and one or more receiving devices 208 to server 202. For example, network 206 may include one or more of a fiber optics network, a passive optical network, a cable network, an Internet network, a satellite network, a wireless LAN, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family network, Bluetooth, NFC, RFID, Wi-Fi, and/or the like.

In addition, network 206 may include, without limitation, telephone lines, fiber optics, IEEE Ethernet 902.3, a wide area network, a wireless personal area network, a LAN, or a global network such as the Internet. In addition, network 206 may support an Internet network, a wireless communication network, a cellular network, or the like, or any combination thereof. Network 206 may further include one network, or any number of the exemplary types of networks mentioned above, operating as a stand-alone network or in cooperation with each other. Network 206 may utilize one or more protocols of one or more network elements to which they are communicatively coupled. Network 206 may translate to or from other protocols to one or more protocols of network devices. Although network 206 is depicted as a single network, it should be appreciated that according to one or more examples, network 206 may comprise a plurality of interconnected networks, such as, for example, the Internet, a service provider's network, a cable television network, corporate networks, such as credit card association networks, and home networks.

In some examples, one or more transmitting devices 204 and one or more receiving devices 208 may be configured to communicate and transmit and receive data between each other without passing through network 206. For example, communication between the one or more transmitting devices 204 and the one or more receiving devices 208 may occur via at least one of NFC, Bluetooth, RFID, Wi-Fi, and/or the like.

At block 210, when the transmitting device 204 is preparing to process the sensitive data with symmetric cryptographic operation, the sender may update a counter. In addition, the transmitting device 204 may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or Advanced Encryption Standard 128 (AES128); a symmetric HMAC algorithm, such as HMAC-SHA-256; and a symmetric CMAC algorithm such as AES-CMAC. It is understood that if the output of the selected symmetric algorithm does not generate a sufficiently long key, techniques such as processing multiple iterations of the symmetric algorithm with different input data and the same master key may produce multiple outputs which may be combined as needed to produce sufficient length keys.

At block 212, the transmitting device 204 may take the selected cryptographic algorithm, and using the master symmetric key, process the counter value. For example, the sender may select a symmetric encryption algorithm, and use a counter which updates with every conversation between the transmitting device 204 and the receiving device 208. The transmitting device 204 may then encrypt the counter value with the selected symmetric encryption algorithm using the master symmetric key, creating a diversified symmetric key.

In some examples, the counter value may not be encrypted. In these examples, the counter value may be transmitted between the transmitting device 204 and the receiving device 208 at block 212 without encryption.

At block 214, the diversified symmetric key may be used to process the sensitive data before transmitting the result to the receiving device 208. For example, the transmitting device 204 may encrypt the sensitive data using a symmetric encryption algorithm using the diversified symmetric key, with the output comprising the protected encrypted data. The transmitting device 204 may then transmit the protected encrypted data, along with the counter value, to the receiving device 208 for processing.

At block 216, the receiving device 208 may first take the counter value and then perform the same symmetric encryption using the counter value as input to the encryption, and the master symmetric key as the key for the encryption. The output of the encryption may be the same diversified symmetric key value that was created by the sender.

At block 218, the receiving device 208 may then take the protected encrypted data and using a symmetric decryption algorithm along with the diversified symmetric key, decrypt the protected encrypted data.

At block 220, as a result of the decrypting the protected encrypted data, the original sensitive data may be revealed.

The next time sensitive data needs to be sent from the sender to the recipient via respective transmitting device 204 and receiving device 208, a different counter value may be selected producing a different diversified symmetric key. By processing the counter value with the master symmetric key and same symmetric cryptographic algorithm, both the transmitting device 204 and receiving device 208 may independently produce the same diversified symmetric key. This diversified symmetric key, not the master symmetric key, is used to protect the sensitive data.

As explained above, both the transmitting device 204 and receiving device 208 each initially possess the shared master symmetric key. The shared master symmetric key is not used to encrypt the original sensitive data. Because the diversified symmetric key is independently created by both the transmitting device 204 and the receiving device 208, it is never transmitted between the two parties. Thus, an attacker cannot intercept the diversified symmetric key and the attacker never sees any data which was processed with the master symmetric key. Only the counter value is processed with the master symmetric key, not the sensitive data. As a result, reduced side-channel data about the master symmetric key is revealed. Moreover, the operation of the transmitting device 204 and the receiving device 208 may be governed by symmetric requirements for how often to create a new diversification value, and therefore a new diversified symmetric key. In an embodiment, a new diversification value and therefore a new diversified symmetric key may be created for every exchange between the transmitting device 204 and receiving device 208.

In some examples, the key diversification value may comprise the counter value. Other non-limiting examples of the key diversification value include: a random nonce generated each time a new diversified key is needed, the random nonce sent from the transmitting device 204 to the receiving device 208; the full value of a counter value sent from the transmitting device 204 and the receiving device 208; a portion of a counter value sent from the transmitting device 204 and the receiving device 208; a counter independently maintained by the transmitting device 204 and the receiving device 208 but not sent between the two devices; a one-time-passcode exchanged between the transmitting device 204 and the receiving device 208; and a cryptographic hash of the sensitive data. In some examples, one or more portions of the key diversification value may be used by the parties to create multiple diversified keys. For example, a counter may be used as the key diversification value. Further, a combination of one or more of the exemplary key diversification values described above may be used.

In another example, a portion of the counter may be used as the key diversification value. If multiple master key values are shared between the parties, the multiple diversified key values may be obtained by the systems and processes described herein. A new diversification value, and therefore a new diversified symmetric key, may be created as often as needed. In the most secure case, a new diversification value may be created for each exchange of sensitive data between the transmitting device 204 and the receiving device 208. In effect, this may create a one-time use key, such as a single-use session key.

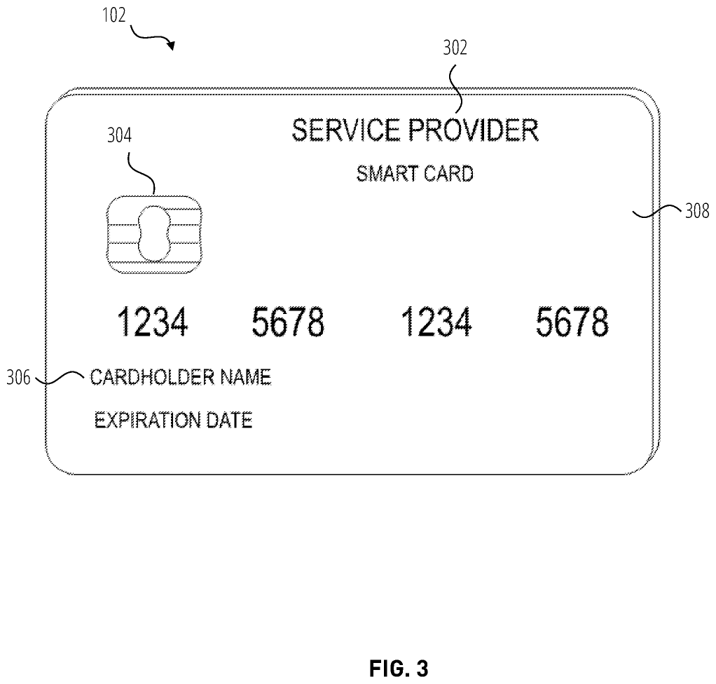

FIG. 3 illustrates an example configuration of a contactless card 1204, which may include a contactless card, a payment card, such as a credit card, debit card, or gift card, issued by a service provider as displayed as service provider indicia 302 on the front or back of the contactless card 1204. In some examples, the contactless card 1204 is not related to a payment card, and may include, without limitation, an identification card. In some examples, the transaction card may include a dual interface contactless payment card, a rewards card, and so forth. The contactless card 1204 may include a substrate 308, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 1204 may have physical characteristics compliant with the ID-1 format of the International Organization for Standardization (ISO)/International Electrotechnical Commission (IEC) 7816 standard, and the transaction card may otherwise be compliant with the ISO/IEC 14443 standard. However, it is understood that the contactless card 1204 according to the present disclosure may have different characteristics, and the present disclosure does not require a transaction card to be implemented in a payment card.

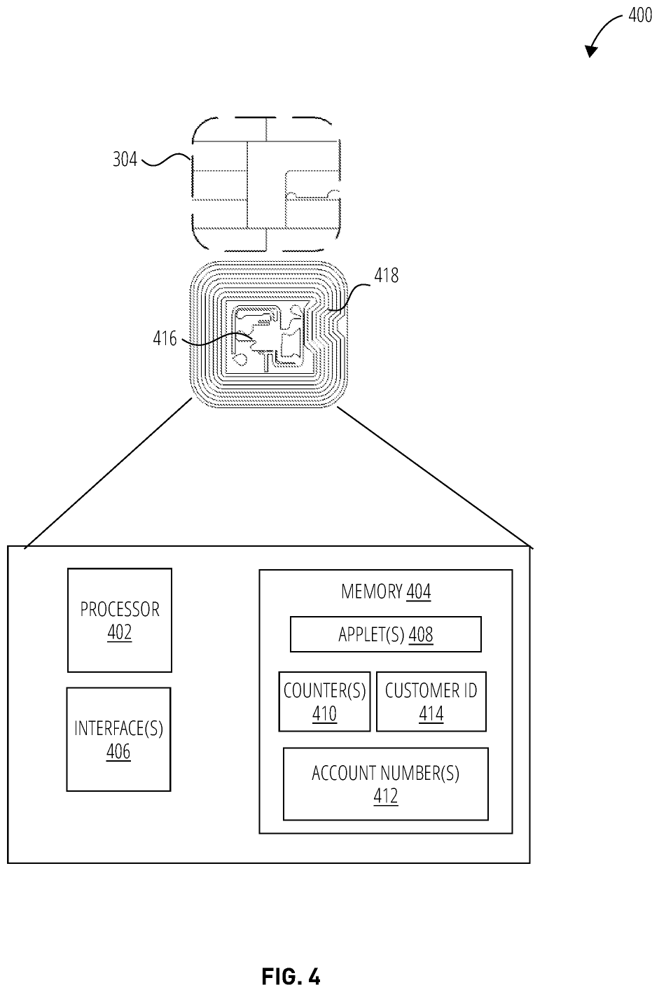

The contactless card 1204 may also include identification information 306 displayed on the front and/or back of the card, and a contact pad 304. The contact pad 304 may include one or more pads and be configured to establish contact with another client device, such as an ATM, a user device, smartphone, laptop, desktop, or tablet computer via transaction cards. The contact pad 304 may be designed in accordance with one or more standards, such as ISO/IEC 7816 standard, and enable communication in accordance with the EMV protocol. The contactless card 1204 may also include processing circuitry, antenna and other components as will be further discussed in FIG. 4. These components may be located behind the contact pad 304 or elsewhere on the substrate 308, e.g. within a different layer of the substrate 308, and may be electrically and physically coupled with the contact pad 304. The contactless card 1204 may also include a magnetic strip or tape, which may be located on the back of the card (not shown in FIG. 3). The contactless card 1204 may also include a NFC device coupled with an antenna capable of communicating via the NFC protocol. Embodiments are not limited in this manner.

As illustrated in FIG. 4, the contact pad 304 of contactless card 102 may include processing circuitry 416 for storing, processing, and communicating information, including a processor 402, a memory 404, and one or more interface(s) 406. It is understood that the processing circuitry 416 may contain additional components, including processors, memories, error and parity/CRC checkers, data encoders, anticollision algorithms, controllers, command decoders, security primitives and tamperproofing hardware, as necessary to perform the functions described herein.

The memory 404 may be a read-only memory, write-once read-multiple memory or read/write memory, e.g., random-access memory (RAM), read-only memory (ROM), and erasable programmable ROM (EPROM), and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 404 may be encrypted memory utilizing an encryption algorithm executed by the processor 402 to encrypt data.

The memory 404 may be configured to store one or more applet(s) 408, one or more counter(s) 410, a customer identifier 414, and the account number(s) 412, which may be virtual account numbers. The one or more applet(s) 408 may comprise one or more software applications configured to execute on one or more contactless cards, such as a Java® Card applet. However, it is understood that applet(s) 408 are not limited to Java Card applets, and instead may be any software application operable on contactless cards or other devices having limited memory. The one or more counter(s) 410 may comprise a numeric counter sufficient to store an integer. The customer identifier 414 may comprise a unique alphanumeric identifier assigned to a user of the contactless card 102, and the customer identifier 414 may distinguish the user of the contactless card from other contactless card users. In some examples, the customer identifier 414 may identify both a customer and an account assigned to that customer and may further identify the contactless card 102 associated with the customer's account. As stated, the account number(s) 412 may include thousands of one-time use virtual account numbers associated with the contactless card 102. An applet(s) 408 of the contactless card 102 may be configured to manage the account number(s) 412 (e.g., to select an account number(s) 412, mark the selected account number(s) 412 as used, and transmit the account number(s) 412 to a mobile device for autofilling by an autofilling service.

The processor 402 and memory 404 elements of the foregoing exemplary embodiments are described with reference to the contact pad 304, but the present disclosure is not limited thereto. It is understood that these elements may be implemented outside of the contact pad 304 or entirely separate from it, or as further elements in addition to processor 402 and memory 404 elements located within the contact pad 304.

In some examples, the contactless card 102 may comprise one or more antenna(s) 418. The one or more antenna(s) 418 may be placed within the contactless card 102 and around the processing circuitry 416 of the contact pad 304. For example, the one or more antenna(s) 418 may be integral with the processing circuitry 416 and the one or more antenna(s) 418 may be used with an external booster coil. As another example, the one or more antenna(s) 418 may be external to the contact pad 304 and the processing circuitry 416.

In an embodiment, the coil of contactless card 102 may act as the secondary of an air core transformer. A terminal may communicate with the contactless card 102 by cutting power or amplitude modulation. The contactless card 101 may infer the data transmitted from the terminal using the gaps in the contactless card's power connection, which may be functionally maintained through one or more capacitors. The contactless card 102 may communicate back by switching a load on the contactless card's coil or load modulation. Load modulation may be detected in the terminal's coil through interference. More generally, using the antenna(s) 418, processor 402, and/or the memory 404, the contactless card 102 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet(s) 408 may be added to contactless cards to provide a one-time password (OTP) for multifactor authentication (MFA) in various mobile application-based use cases. Applet(s) 408 may be configured to respond to one or more requests, such as near field data exchange requests, from a reader, such as a mobile NFC reader (e.g., of a mobile device or point-of-sale terminal), and produce a near field data exchange (NDEF) message that comprises a cryptographically secure OTP encoded as an NDEF text tag.

One example of an NDEF OTP is an NDEF short-record layout (SR=1). In such an example, one or more applet(s) 408 may be configured to encode the OTP as an NDEF type 4 well known type text tag. In some examples, NDEF messages may comprise one or more records. The applet(s) 408 may be configured to add one or more static tag records in addition to the OTP record.

In some examples, the one or more applet(s) 408 may be configured to emulate an RFID tag. The RFID tag may include one or more polymorphic tags. In some examples, each time the tag is read, different cryptographic data is presented that may indicate the authenticity of the contactless card. Based on the one or more applet(s) 408, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter(s) 410 may be configured to increment. In some examples, each time data from the contactless card 102 is read (e.g., by a mobile device), the counter(s) 410 is transmitted to the server for validation and determines whether the counter(s) 410 are equal (as part of the validation) to a counter of the server.

The one or more counter(s) 410 may be configured to prevent a replay attack. For example, if a cryptogram has been obtained and replayed, that cryptogram is immediately rejected if the counter(s) 410 has been read or used or otherwise passed over. If the counter(s) 410 has not been used, it may be replayed. In some examples, the counter that is incremented on the card is different from the counter that is incremented for transactions. The contactless card 102 is unable to determine the application transaction counter(s) 410 since there is no communication between applet(s) 408 on the contactless card 102.

In some examples, the counter(s) 410 may get out of sync. In some examples, to account for accidental reads that initiate transactions, such as reading at an angle, the counter(s) 410 may increment but the application does not process the counter(s) 410. In some examples, when a mobile device 104 is woken up, NFC may be enabled and the device 104 may be configured to read available tags, but no action is taken responsive to the reads.

To keep the counter(s) 410 in sync, an application, such as a background application, may be executed that would be configured to detect when the mobile device 104 wakes up and synchronizes with the server of a banking system indicating that a read that occurred due to detection to then move the counter(s) 410 forward. In other examples, Hashed One Time Password may be utilized such that a window of mis-synchronization may be accepted. For example, if within a threshold of 10, the counter(s) 410 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 410 increases in the appropriate sequence, then it possible to know that the user has done so.

The key diversification technique described herein with reference to the counter(s) 410, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple Data Encryption Standard (DES) (3DES) algorithm may be used by EMV and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 101 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal American Standard Code for Information Interchange (ASCII) format. In another example, the NDEF record may be encoded in hexadecimal format.

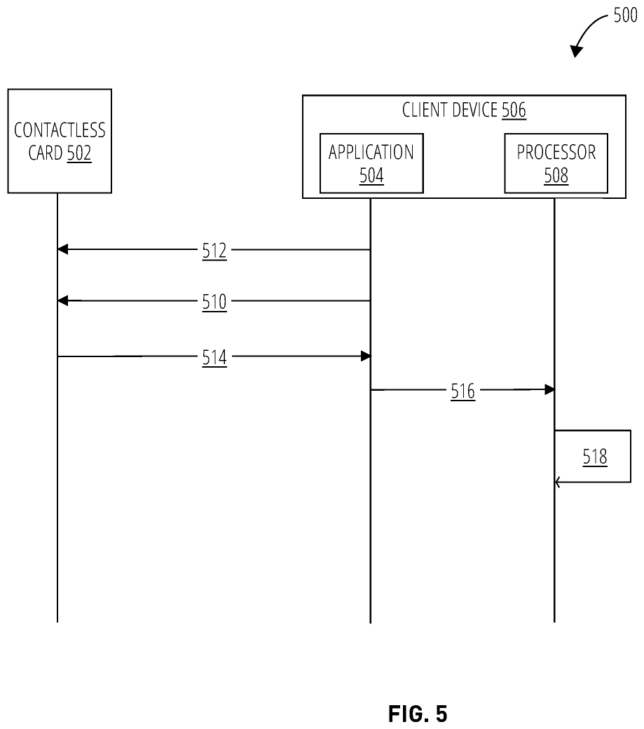

FIG. 5 is a timing diagram illustrating an example sequence for providing authenticated access according to one or more embodiments of the present disclosure. Sequence flow 500 may include contactless card 502 and client device 506, which may include an application 504 and processor 508.

At line 512, the application 504 communicates with the contactless card 502 (e.g., after being brought near the contactless card 502). Communication between the application 504 and the contactless card 502 may involve the contactless card 502 being sufficiently close to a card reader (not shown) of the client device 506 to enable NFC data transfer between the application 504 and the contactless card 502.

At line 510, after communication has been established between client device 506 and contactless card 502, contactless card 502 generates a message authentication code (MAC) cryptogram. In some examples, this may occur when the contactless card 502 is read by the application 504. In particular, this may occur upon a read, such as an NFC read, of a NDEF tag, which may be created in accordance with the NFC Data Exchange Format. For example, a reader application, such as application 504, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 502 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 504 may be configured to transmit a request to contactless card 502, the request comprising an instruction to generate a MAC cryptogram.

At line 514, the contactless card 502 sends the MAC cryptogram to the application 504. In some examples, the transmission of the MAC cryptogram occurs via NFC, however, the present disclosure is not limited thereto. In other examples, this communication may occur via Bluetooth, Wi-Fi, or other means of wireless data communication. At line 516, the application 504 communicates the MAC cryptogram to the processor 508.

At line 518, the processor 508 verifies the MAC cryptogram pursuant to an instruction from the application 504. For example, the MAC cryptogram may be verified, as explained below. In some examples, verifying the MAC cryptogram may be performed by a device other than client device 506, such as a server of a banking system in data communication with the client device 506. For example, processor 508 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the Rivest-Shamir-Adleman (RSA) algorithm, or zero knowledge protocols, may be used to perform this verification.

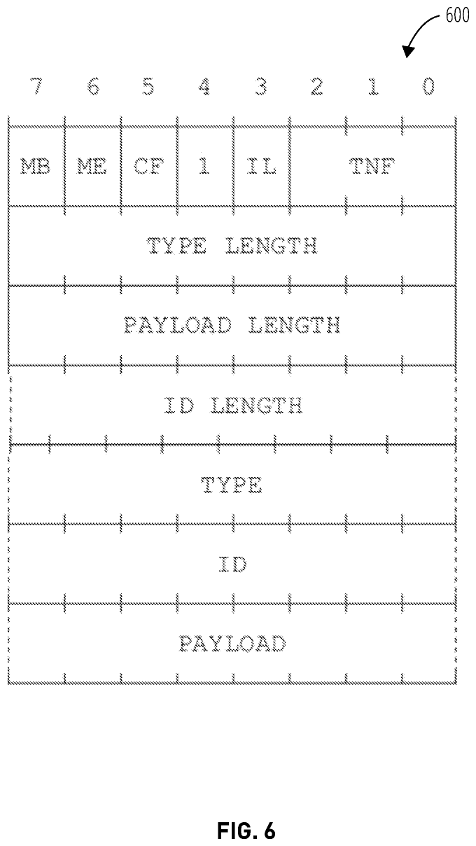

FIG. 6 illustrates an NDEF short-record layout (SR=1) data structure 600 according to an example embodiment. One or more applets may be configured to encode the OTP as an NDEF type 4 well known type text tag. In some examples, NDEF messages may comprise one or more records. The applets may be configured to add one or more static tag records in addition to the OTP record. Exemplary tags include, without limitation, Tag type: well known type, text, encoding English (en); Applet ID: D2760000850101; Capabilities: read-only access; Encoding: the authentication message may be encoded as ASCII hex; type-length-value (TLV) data may be provided as a personalization parameter that may be used to generate the NDEF message. In an embodiment, the authentication template may comprise the first record, with a well-known index for providing the actual dynamic authentication data.

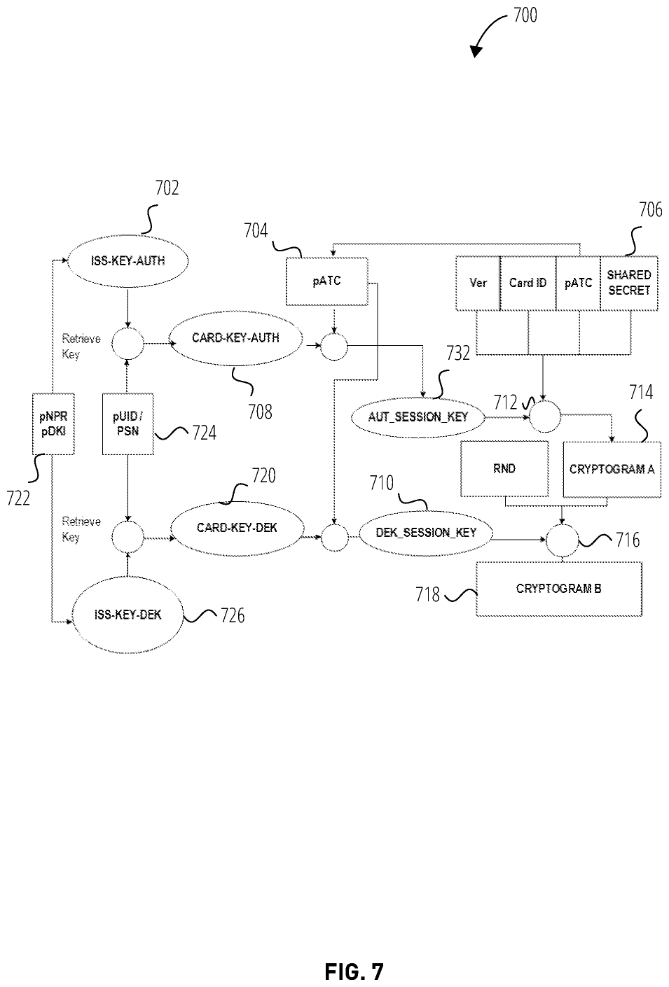

FIG. 7 illustrates a system 700 configured to implement one or more embodiments of the present disclosure. As explained below, during the contactless card creation process, two cryptographic keys may be assigned uniquely for each card. The cryptographic keys may comprise symmetric keys which may be used in both encryption and decryption of data. Triple DES (3DES) algorithm may be used by EMV and it is implemented by hardware in the contactless card. By using a key diversification process, one or more keys may be derived from a master key based upon uniquely identifiable information for each entity that requires a key.

Regarding master key management, two issuer master keys 702, 726 may be required for each part of the portfolio on which the one or more applets is issued. For example, the first master key 702 may comprise an Issuer Cryptogram Generation/Authentication Key (Iss-Key-Auth) and the second master key 726 may comprise an Issuer Data Encryption Key (Iss-Key-DEK). As further explained herein, two issuer master keys 702, 726 are diversified into card master keys 708, 720, which are unique for each card. In some examples, a network profile record ID (pNPR) 722 and derivation key index (pDKI) 724, as back office data, may be used to identify which Issuer Master Keys 702, 726 to use in the cryptographic processes for authentication. The system performing the authentication may be configured to retrieve values of pNPR 722 and pDKI 724 for a contactless card at the time of authentication.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 708 and Card-Key-Dek 720). The session keys (Aut-Session-Key 732 and DEK-Session-Key 710) may be generated by the one or more applets and derived by using the application transaction counter (pATC) 704 with one or more algorithms. To fit data into the one or more algorithms, only the 2 low order bytes of the 4-byte pATC 704 is used. In some examples, the four byte session key derivation method may comprise: F1:=PATC(lower 2 bytes)∥‘F0’∥‘00’∥PATC (four bytes) F1:=PATC(lower 2 bytes)∥‘0F’∥‘00’∥PATC (four bytes) SK:={(ALG (MK) [F1])∥ALG (MK) [F2]}, where ALG may include 3DES Electronic Code Book (ECB) and MK may include the card unique derived master key.

As described herein, one or more MAC session keys may be derived using the lower two bytes of pATC 704 counter. At each tap of the contactless card, pATC 704 is configured to be updated, and the card master keys Card-Key-AUTH 708 and Card-Key-DEK 720 are further diversified into the session keys Aut-Session-Key 732 and DEK-Session-KEY 710. pATC 704 may be initialized to zero at personalization or applet initialization time. In some examples, the pATC 704 counter may be initialized at or before personalization, and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In some examples, only the authentication data and an 8-byte random number followed by MAC of the authentication data may be included. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 732. The data specified in cryptogram may be processed with javacard.signature method: ALG_DES_MAC8_ISO9797_1_M2_ALG3 to correlate to EMV Authorization Request Cryptogram (ARQC) verification methods. The key used for this computation may comprise a session key AUT-Session-Key 732, as explained above. As explained above, the low order two bytes of the counter may be used to diversify for the one or more MAC session keys. As explained below, AUT-Session-Key 732 may be used to encrypt MAC data 706, and the resulting data or cryptogram A 714 and random number RND may be encrypted using DEK-Session-Key 710 to create cryptogram B or output 718 sent in the message.

In some examples, one or more Hardware Security Module (HSM) commands may be processed for decrypting such that the final 16 (binary, 32 hex) bytes may comprise a 3DES symmetric encrypting using cipher-block chain (CBC) mode with a zero IV of the random number followed by MAC authentication data. The key used for this encryption may comprise a session key DEK-Session-Key 710 derived from the Card-Key-DEK 720. In this case, an Application Transaction Value (ATC) value for the session key derivation is the least significant byte of the counter pATC 704.

The format below represents a binary version example embodiment. Further, in some examples, the first byte may be set to ASCII ‘A’.

| | | | | |
|---|---|---|---|---|
| Message Format | | | | |
| 1 | 2 | 4 | 8 | 8 |
| 0x43 (Message | Version | pATC | RND | Cryptogram A |
| Type ‘A’) | | | | (MAC) |
| Cryptogram A | 8 | | | |
| (MAC) | bytes | | | |
| MAC of | | | | |
| 2 | 8 | 4 | 4 | 18 bytes input data |
| Version | pUID | pATC | Shared Secret | |
| Message Format | | | | |
| 1 | 2 | 4 | 16 | |
| 0x43 (Message | Version | pATC | Cryptogram B | |
| Type ‘A’) | | | | |
| Cryptogram A | 8 | | | |
| (MAC) | bytes | | | |
| MAC of | | | | |
| 2 | 8 | 4 | 4 | 18 bytes input data |
| Version | pUID | pATC | Shared Secret | |
| Cryptogram B | 16 | | | |
| Sym Encryption | | | | |
| of | | | | |
| 8 | 8 | | | |
| RND | Cryptogram | | | |
| | A | | | |

Another exemplary format is shown below. In this example, the tag may be encoded in hexadecimal format.

| | | | | |
|---|---|---|---|---|
| Message Format | | | | |
| 2 | 8 | 4 | 8 | 8 |
| Version | pUID | pATC | RND | Cryptogram A |
| | | | | (MAC) |
| 8 bytes | | | | |
| 8 | 8 | 4 | 4 | 18 bytes input data |
| pUID | pUID | pATC | Shared Secret | |
| Message Format | | | | |
| 2 | 8 | 4 | 16 | |
| Version | pUID | pATC | Cryptogram B | |
| 8 bytes | | | | |
| 8 | | 4 | 4 | 18 bytes input data |
| pUID | pUID | pATC | Shared Secret | |
| Cryptogram B | 16 | | | |
| Sym Encryption | | | | |
| of | | | | |
| 8 | 8 | | | |
| RND | Cryptogram | | | |
| | A | | | |

A Unique Identifier (UID) field of the received message may be extracted to derive, from master keys Iss-Key-AUTH 702 and Iss-Key-DEK 726, the card master keys (Card-Key-Auth 708 and Card-Key-DEK 720) for that particular card. Using the card master keys (Card-Key-Auth 708 and Card-Key-DEK 720), the counter (pATC) field of the received message may be used to derive the session keys (Aut-Session-Key 732 and DEK-Session-Key 710) for that particular card. Cryptogram B 718 may be decrypted using the DEK-Session-KEY, which yields cryptogram A 714 and RND, and RND may be discarded. The UID field may be used to look up the shared secret of the contactless card which, along with the Ver, UID, and pATC fields of the message, may be processed through the cryptographic MAC using the re-created Aut-Session-Key to create a MAC output, such as MAC′. If MAC′ is the same as cryptogram A 714, then this indicates that the message decryption and MAC checking have all passed. Then the pATC may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 732. The input data 706 may take the following form: Version (2), pUID (8), pATC (4), Shared Secret (4). In some examples, the numbers in the brackets may comprise length in bytes. In some examples, the shared secret may be generated by one or more random number generators which may be configured to ensure, through one or more secure processes, that the random number is unpredictable. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x‘80’ byte to the end of input data and 0x‘00’ bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC mode of the symmetric encryption algorithm. This allows the “scrambling” from block to block without having to pre-establish either a fixed or dynamic IV.

By including the application transaction counter (pATC) as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some examples, the pATC may start at zero and be updated by 1 each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and the authenticated may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 712, data 706 is processed through the MAC using Aut-Session-Key 732 to produce MAC output (cryptogram A) 714, which is encrypted.

In order to provide additional protection against brute force attacks exposing the keys on the card, it is desirable that the MAC output (cryptogram A) 714 be enciphered. In some examples, data or cryptogram A 714 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 710. In the encryption operation 716, data or cryptogram A 714 and RND are processed using DEK-Session-Key 710 to produce encrypted data, cryptogram B 718. The MAC output (cryptogram A) 714 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0x‘0000000000000000’ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

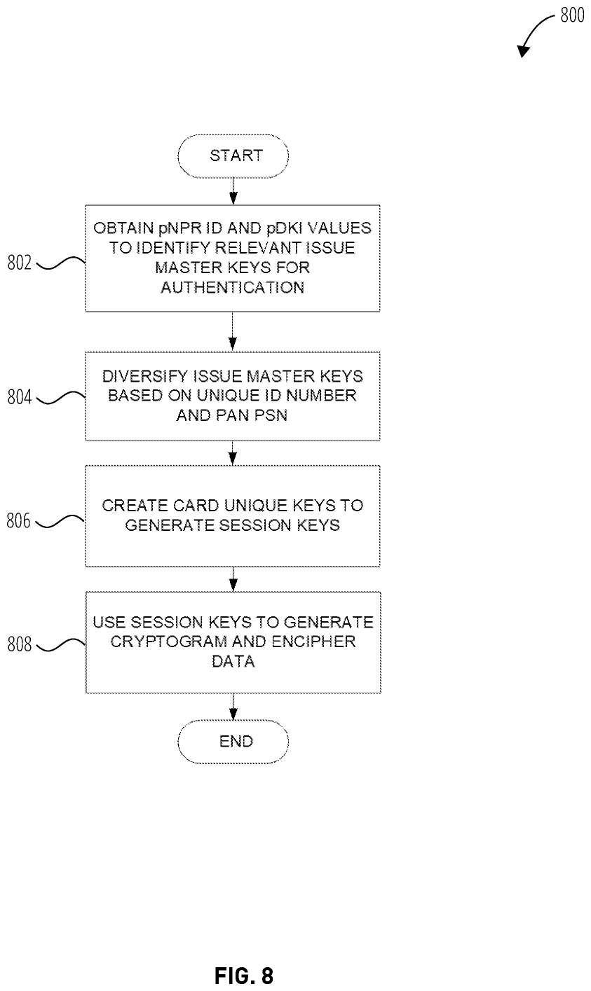

FIG. 8 illustrates a method 800 for generating a cryptogram. For example, at block 802, a network profile record ID (pNPR) and derivation key index (pDKI) may be used to identify which Issuer Master Keys to use in the cryptographic processes for authentication. In some examples, the method may include performing the authentication to retrieve values of pNPR and pDKI for a contactless card at the time of authentication.

At block 804, Issuer Master Keys may be diversified by combining them with the card's unique ID number (pUID) and the Personal Area Network (PAN) sequence number (PSN) of one or more applets, for example, a payment applet.

At block 806, Card-Key-Auth and Card-Key-DEK (unique card keys) may be created by diversifying the Issuer Master Keys to generate session keys which may be used to generate a MAC cryptogram.

At block 808, the keys used to generate the cryptogram and encipher the data in the one or more applets may comprise the session keys of block 806 based on the card unique keys (Card-Key-Auth and Card-Key-DEK). In some examples, these session keys may be generated by the one or more applets and derived by using pATC, resulting in session keys Aut-Session-Key and DEK-Session-Key.

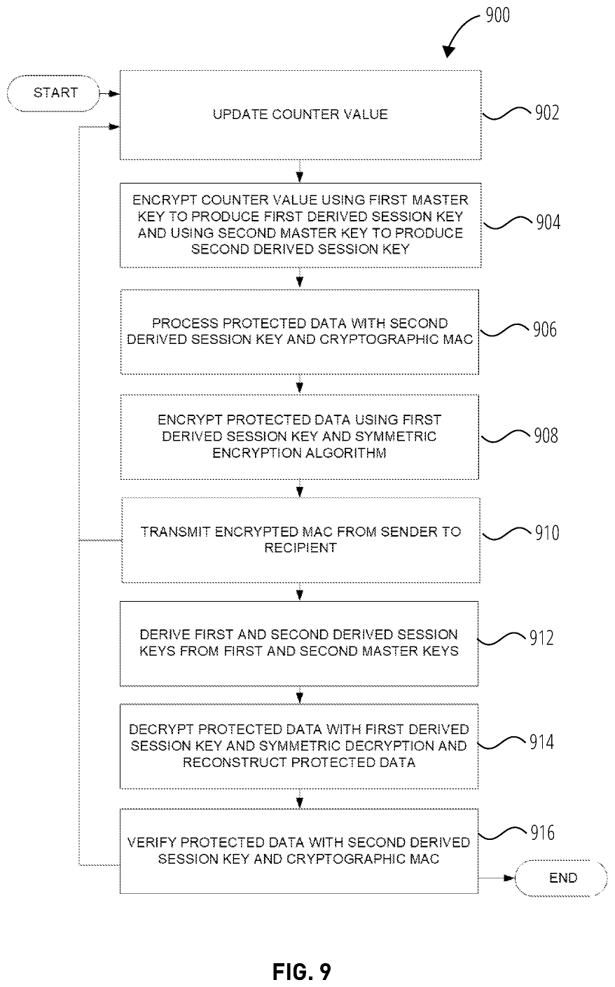

FIG. 9 depicts an exemplary process 900 illustrating key diversification according to one example. Initially, a sender and the recipient may be provisioned with two different master keys. For example, a first master key may comprise the data encryption master key, and a second master key may comprise the data integrity master key. The sender has a counter value, which may be updated at block 902, and other data, such as data to be protected, which it may secure share with the recipient.

At block 904, the counter value may be encrypted by the sender using the data encryption master key to produce the data encryption derived session key, and the counter value may also be encrypted by the sender using the data integrity master key to produce the data integrity derived session key. In some examples, a whole counter value or a portion of the counter value may be used during both encryptions.

In some examples, the counter value may not be encrypted. In these examples, the counter may be transmitted between the sender and the recipient in the clear, i.e., without encryption.

At block 906, the data to be protected is processed with a cryptographic MAC operation by the sender using the data integrity session key and a cryptographic MAC algorithm. The protected data, including plaintext and shared secret, may be used to produce a MAC using one of the session keys (AUT-Session-Key).

At block 908, the data to be protected may be encrypted by the sender using the data encryption derived session key in conjunction with a symmetric encryption algorithm. In some examples, the MAC is combined with an equal amount of random data, for example each 8 bytes long, and then encrypted using the second session key (DEK-Session-Key).

At block 910, the encrypted MAC is transmitted, from the sender to the recipient, with sufficient information to identify additional secret information (such as shared secret, master keys, etc.), for verification of the cryptogram.

At block 912, the recipient uses the received counter value to independently derive the two derived session keys from the two master keys as explained above.

At block 914, the data encryption derived session key is used in conjunction with the symmetric decryption operation to decrypt the protected data. Additional processing on the exchanged data will then occur. In some examples, after the MAC is extracted, it is desirable to reproduce and match the MAC. For example, when verifying the cryptogram, it may be decrypted using appropriately generated session keys. The protected data may be reconstructed for verification. A MAC operation may be performed using an appropriately generated session key to determine if it matches the decrypted MAC. As the MAC operation is an irreversible process, the only way to verify is to attempt to recreate it from source data.

At block 916, the data integrity derived session key is used in conjunction with the cryptographic MAC operation to verify that the protected data has not been modified.

Some examples of the methods described herein may advantageously confirm when a successful authentication is determined when the following conditions are met. First, the ability to verify the MAC shows that the derived session key was proper. The MAC may only be correct if the decryption was successful and yielded the proper MAC value. The successful decryption may show that the correctly derived encryption key was used to decrypt the encrypted MAC. Since the derived session keys are created using the master keys known only to the sender (e.g., the transmitting device) and recipient (e.g., the receiving device), it may be trusted that the contactless card which originally created the MAC and encrypted the MAC is indeed authentic. Moreover, the counter value used to derive the first and second session keys may be shown to be valid and may be used to perform authentication operations.

Thereafter, the two derived session keys may be discarded, and the next iteration of data exchange will update the counter value (returning to block 902) and a new set of session keys may be created (at block 910). In some examples, the combined random data may be discarded.

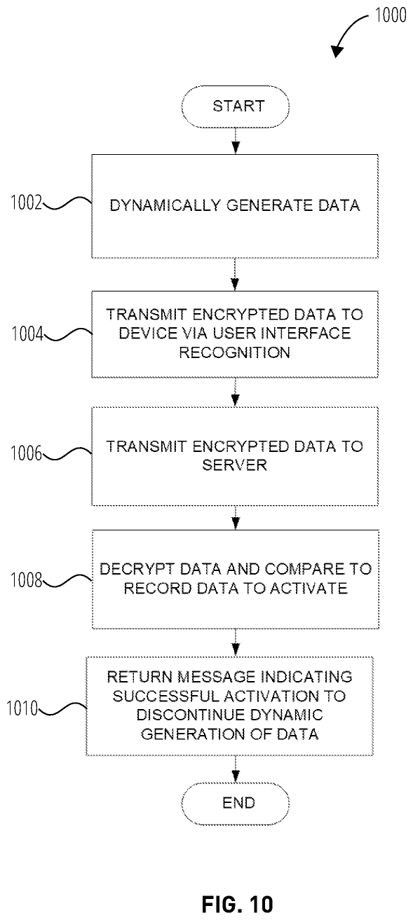

FIG. 10 illustrates a method 800 for card activation according to an example embodiment. For example, card activation may be completed by a system including a card, a device, and one or more servers. The contactless card, device, and one or more servers may reference same or similar components that were previously explained, such as a contactless card 102, a client device 104, and a server.

In block 1002, the card may be configured to dynamically generate data. In some examples, this data may include information such as an account number, card identifier, card verification value, or phone number, which may be transmitted from the card to the device. In some examples, one or more portions of the data may be encrypted via the systems and methods disclosed herein.

In block 1004, one or more portions of the dynamically generated data may be communicated to an application of the device via NFC or other wireless communication. For example, a tap of the card proximate to the device may allow the application of the device to read the one or more portions of the data associated with the contactless card. In some examples, if the device does not comprise an application to assist in activation of the card, the tap of the card may direct the device or prompt the customer to a software application store to download an associated application to activate the card. In some examples, the user may be prompted to sufficiently gesture, place, or orient the card towards a surface of the device, such as either at an angle or flatly placed on, near, or proximate the surface of the device. Responsive to a sufficient gesture, placement and/or orientation of the card, the device may proceed to transmit the one or more encrypted portions of data received from the card to the one or more servers.

In block 1006, the one or more portions of the data may be communicated to one or more servers, such as a card issuer server. For example, one or more encrypted portions of the data may be transmitted from the device to the card issuer server for activation of the card.

In block 1008, the one or more servers may decrypt the one or more encrypted portions of the data via the systems and methods disclosed herein. For example, the one or more servers may receive the encrypted data from the device and may decrypt it in order to compare the received data to record data accessible to the one or more servers. If a resulting comparison of the one or more decrypted portions of the data by the one or more servers yields a successful match, the card may be activated. If the resulting comparison of the one or more decrypted portions of the data by the one or more servers yields an unsuccessful match, one or more processes may take place. For example, responsive to the determination of the unsuccessful match, the user may be prompted to tap, swipe, or wave gesture the card again. In this case, there may be a predetermined threshold comprising a number of attempts that the user is permitted to activate the card. Alternatively, the user may receive a notification, such as a message on his or her device indicative of the unsuccessful attempt of card verification and to call, email or text an associated service for assistance to activate the card, or another notification, such as a phone call on his or her device indicative of the unsuccessful attempt of card verification and to call, email or text an associated service for assistance to activate the card, or another notification, such as an email indicative of the unsuccessful attempt of card verification and to call, email or text an associated service for assistance to activate the card.

In block 1010, the one or more servers may transmit a return message based on the successful activation of the card. For example, the device may be configured to receive output from the one or more servers indicative of a successful activation of the card by the one or more servers. The device may be configured to display a message indicating successful activation of the card. Once the card has been activated, the card may be configured to discontinue dynamically generating data so as to avoid fraudulent use. In this manner, the card may not be activated thereafter, and the one or more servers are notified that the card has already been activated.

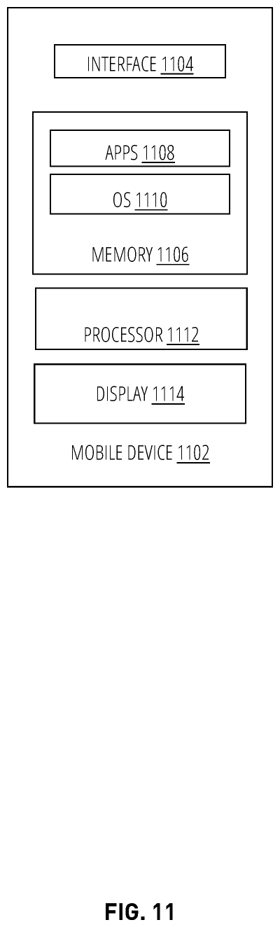

FIGS. 1-10 are generally directed to systems and methods to authenticate a contactless card based on information on the contactless card. However, as previously discussed, some embodiments disclosed herein can include systems and methods for increasing security for digital transactions with predetermined risk factors. For example, in some embodiments, systems and methods disclosed herein can determine when a digital transaction initiated in connection with a user account satisfies at least one predetermined risk factor. In these instances, instead of simply executing the digital transaction, systems and methods disclosed herein can increase security to verify that the digital transaction is likely being initiated by an authorized user of the user account prior to executing the user account. FIGS. 11-14 are generally directed to these embodiments and provide additional details thereof.

FIG. 11 is a block diagram that illustrates an example of a mobile device 1102 in accordance with disclosed embodiments. It is to be understood that the mobile device 1102 can be the same as or similar to the client device 104.

As seen, the mobile device 1102 can include an interface 1104, a memory 1106, a processor 1112, and a display device 1114. The memory 1106 can be configured to store computer instructions configured to be executed by the processor 1112 to cause the processor 1112 to execute certain actions, and the computer instructions can be part of applications 1108 and/or an operating system 1110.

In some embodiments, the interface 1104 can include one or more antennas, such as a short-range communication antenna, one or more user interface devices, such as a key pad with hard or soft keys, and/or a camera, a scanner, a card reader, or another device capable of reading or capturing images, information, or data within its field of view. Additionally or alternatively, the interface 1104 can include a WiFi interface, a Bluetooth interface, an NFC interface, a serial bus interface, a universal serial bus (USB), and so forth.

In some embodiments, the memory 1106 can be any type of memory configured to store instructions to be processed by the processor 1112. Examples of the memory 1106 can include volatile or non-volatile memory, removable or non-removable memory, erasable or non-erasable memory, writeable or re-writeable memory, and so forth.

In some embodiments, the processor 1112 can be any type of processor, microprocessor, circuit, circuit element (e.g., transistor, resistor, capacitor, inductor, and so forth), integrated circuit, application specific integrated circuit (ASIC), programmable logic device (PLD), digital signal processor (DSP), field programmable gate array (FPGA), multi-core processor, and so forth.

In some embodiments, the display device 1114 can include a display screen or other output device for displaying data, information, and/or graphics to a user of the mobile device 1102.

As explained above, the memory 1106 can include the applications 1108 and/or the operating system 1110. The applications 1108 can include any type of application configured to operate on the mobile device 1102. For example, the applications 1108 can include social networking applications, communication applications, business productivity applications (e.g., email, word processor, spreadsheet, etc.), storefront applications, money transfer applications, gaming applications, merchant applications, shopping mobile applications, and so forth. Of particular relevance to some embodiments disclosed herein, the applications 1108 can include mobile banking applications and/or mobile credit card applications.

The applications 1108 can be configured to operate within the operating system 1110. In some embodiments, the operating system 1110 can be an Android® operating system, Apple iOS® operating system, Windows Mobile Operating System®, and so forth. The operating system 1110 can be configured to provide services and instructions that execute and enable the applications 1108 to operate with hardware. For example, the operating system 1110 can be configured to operate with the hardware associated with the processor 1112 to process detections made by the interface 1104. In some embodiments, the operating system 1110 can provide data to the applications 1108 processed by the operating system 1110. The applications 1108 can process such data, including performing authentications of the data, communicating the data to other devices or servers, and so forth. In some embodiments, at least a portion of the operating system 1110 can be configured to perform one or more verification and/or authentication steps.

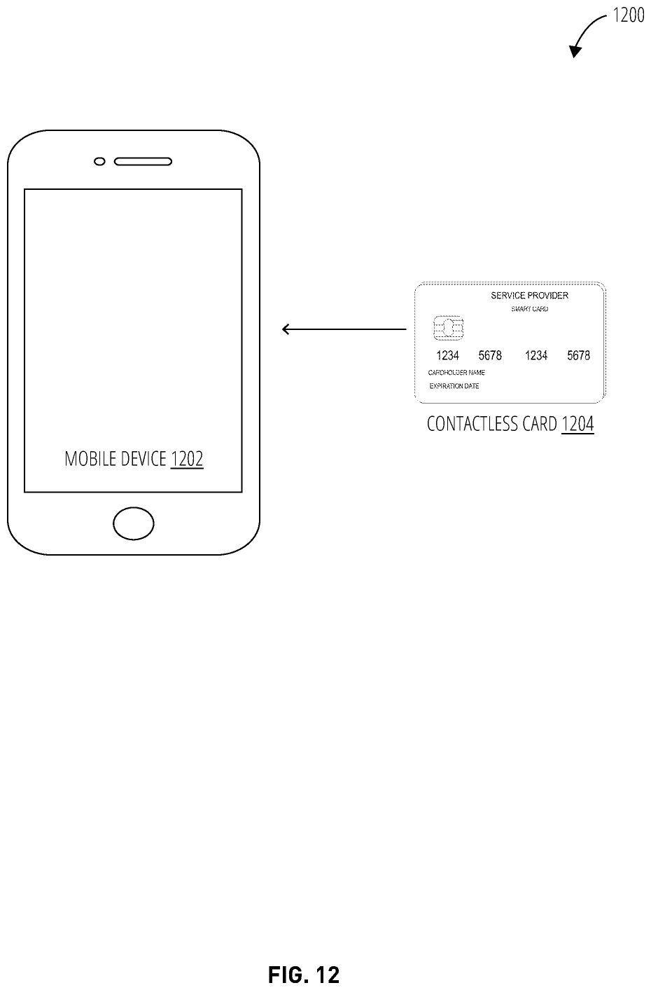

FIG. 12 is a block diagram that illustrates an example of a system 1200 in accordance with disclosed embodiments. As seen, the system 1200 can include a mobile device 1202 and a contactless card 1204. It is to be understood that the mobile device 1202 can be the same as or similar to the mobile device 1102 and/or the client device 104. It is also to be understood that the contactless card 1204 can be the same as or similar to the contactless card 102. The contactless card 1204 can be associated with a user account of a bank or a company that issued the contactless card 1204, and a phone number of the mobile device 1202 can also be associated with the user account.

In some embodiments, a digital transaction can be initiated in connection with the user account via an Internet browser on a desktop computer or the mobile device 1202 or via a mobile application on the mobile device 1202. Regardless of where the digital transaction was initiated, systems and methods disclosed herein can determine whether the digital transaction satisfies at least one predetermined risk factor. For example, in some embodiments, the mobile device 1202 and/or a server in communication with the desktop computer or the mobile device 1202 can determine whether the digital transaction satisfies the at least one predetermined risk factor.

When the digital transaction satisfies the at least one predetermined risk factor, systems and methods disclosed herein can solicit communication between the contactless card 1204 and the mobile device 1202. For example, the desktop computer and/or the mobile device 1202 can display or emit a solicitation for the communication between the contactless card and the mobile device 1202. When the digital transaction is initiated via the Internet browser on the desktop computer or the mobile device 1202, the solicitation can include instructions to access the mobile application on the mobile device 1202.

Then, a user can tap or otherwise bring the contactless card 1204 within a communication range of the mobile device, and the mobile device 1202 can read a cryptogram from the contactless card 1204 and/or the contactless card 1204 can transmit the cryptogram to the mobile device 1202. In operation, the mobile device 1202 and/or the server can verify the cryptogram to identify the user account and to confirm that the contactless card is 1204 associated with the user account. In particular, when the user account identified with the cryptogram matches the user account with which the digital transaction was initiated, the mobile device 1202 and/or the server can confirm that the contactless card is associated with the user account. In some embodiments, the mobile device 1202 can successfully decrypt the cryptogram to identify the user account. In particular, in some embodiments, the mobile device 1202 can decrypt protected data in the cryptogram and compare the protected data to record data associated with the contactless card 1204 and stored on the mobile device 1202 and/or the server. When the protected data matches the record data, the mobile device 1202 can identify the user account associated therewith. However, in some embodiments, the mobile device 1202 can transmit the cryptogram to the server to verify the cryptogram and to identify the user account, for example, as discussed in FIGS. 1-10. In particular, in some embodiments, the server can decrypt the protected data in the cryptogram and compare the protected data to the record data associated with the contactless card 1204 and stored on the server. When the protected data matches the record data, the server can identify the user account associated therewith.

When the cryptogram has been verified, the user account has been identified, and the contactless card 1204 has been confirmed as being associated with the user account, the mobile device 1202 and/or the server can verify that a phone number of the mobile device is associated with the user account. For example, in some embodiments, the mobile device 1202 and/or the server can call or otherwise contact or connect with a mobile network operator to identify the phone number of the mobile device. In these embodiments, the mobile device 1202 and/or the server can contact the mobile network operator on a back end to solicit the phone number associated with the mobile device, thereby executing a silent mobile authentication. However, in some embodiments, the mobile device 1202 can transmit the phone number of the mobile device 1202 to the server to verify that the phone number of the mobile device 1202 is associated with the user account. In these embodiments, the silent mobile authentication can include the mobile application, the mobile device 1202, and/or the server contacting the mobile network operator via a cellular phone system or the like to verify that the phone number of the mobile device 1202 matches data maintained by the mobile network operator. For example, the mobile application, the mobile device 1202, and/or the server can transmit the phone number of the mobile device to the mobile network operator, and the mobile network operator can search its data (e.g., data store, database, etc.) to determine whether a match is identified. When the mobile network operator matches the phone number of the mobile device 1202 with the data maintained by the mobile network operator, the mobile network operator can transmit a verification message to the mobile application, the mobile device 1202, and/or the server.

In some embodiments, the silent mobile authentication can also verify that a SIM card of the mobile device 1202 has not been fraudulently swapped. Indeed, when the SIM card is legitimately swapped into the mobile device 1202, an International Mobile Subscriber Identity (IMSI) number of the SIM card is associated with the phone number of the mobile device 1202. However, when the SIM card is fraudulently swapped, no such network action is taken. As such, the mobile application, the mobile device 1202, and/or the server can transmit the IMSI number of the SIM card in the mobile device 1202 with the phone number of the mobile device 1202 to the mobile network operator, and the mobile network operator can search its data to determine whether the IMSI number of the SIM card matches the phone number of the mobile device 1202. When the mobile network operator matches the IMSI number of the SIM card with the phone number of the mobile device 1202, the mobile network operator can transmit the verification message to the mobile application, the mobile device 1202, and/or the server.

When the cryptogram has been verified, the user account has been identified, and both the contactless card 1204 and the phone number of the mobile device 1202 have been confirmed and verified as being associated with the user account, the mobile device 1202 and/or the server can authorize execution of the digital transaction in connection with the user account. For example, in some embodiments, the mobile device 1202 and/or the server can transmit one or more messages indicating that all security measures have been satisfied to execute the digital transaction in connection with the user account. Additionally or alternatively, in some embodiments, the mobile device 1202 and/or the server can transmit one or more messages with instructions to execute the digital transaction in connection with the user account.

It is to be understood that, in some embodiments, the user account associated with the contactless card 1204 will not be identified unless the phone number of the mobile device 1202 is associated with the user account. Additionally or alternatively, it is to be understood that, in some embodiments, the phone number of the mobile device 1202 will not be verified as being associated with the user account unless the user account is associated with the contactless card 1204. In this regard, without these conditions being satisfied, the mobile device 1202 and/or the server may not be capable of decrypting the cryptogram and/or the protected data in the cryptogram, for example, due to lacking required keys and the like. Additionally or alternatively, without these conditions being satisfied, the mobile device 1202 and/or the server may be able to decrypt the cryptogram and/or the protected data in the cryptogram, but may not be able to match the protected data to any record data stored for registered cards. In this regard, the contactless card 1204 can be associated with the user account and the user account can be associated with the mobile device 1202 and/or the phone number of the mobile device 1202 in a database or a data store maintained by the server. As such, the mobile device 1202 can provide the cryptogram received from the contactless card 1204 as well identifying data, such as identifiers of the mobile device and/or the phone number of the mobile device, to the server, and the server can utilize such received information to identify the user account and verify that the user account is associated with the mobile device 1202 and/or the phone number of the mobile device.

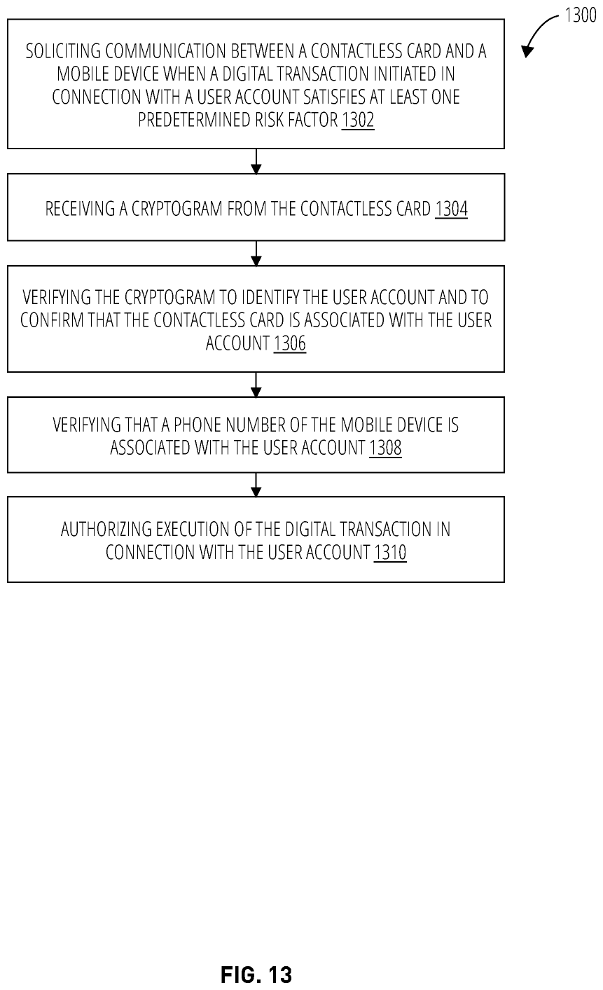

FIG. 13 is a flow chart that illustrates an example of a method 1300 in accordance with disclosed embodiments. In some embodiments, a mobile device, such as the mobile device 1202, the mobile device 1102, and/or the client device 104, can execute some or all of the method 1300. Additionally or alternatively, in some embodiments, a server in communication with the mobile device can execute some or all of the method 1300.

As seen, the method 1300 can include soliciting communication between a contactless card and a mobile device when a digital transaction initiated in connection with a user account satisfies at least one predetermined risk factor as in 1302. For example, in some embodiments, the digital transaction can be initiated via an Internet browser on a desktop computer or the mobile device or via a mobile application on the mobile device. Regardless of where the digital transaction was initiated, a processor of the mobile device and/or the server can determine whether the digital transaction satisfies the at least one predetermined risk factor. In some embodiments, the desktop computer and/or the mobile device can display or emit a solicitation for the communication between the contactless card and the mobile device. When the digital transaction is initiated via the Internet browser on the desktop computer or the mobile device, the solicitation can include instructions to access the mobile application on the mobile device.

Then, the method 1300 can include receiving a cryptogram from a contactless card as in 1304. For example, in some embodiments, a short-range communication antenna of the mobile device can receive the cryptogram from the contactless card.

After receiving the cryptogram as in 1304, the method 1300 can include verifying the cryptogram to identify the user account and to confirm that the contactless card is associated with the user account as in 1306. In particular, when the user account identified with the cryptogram matches the user account with which the digital transaction was initiated, the mobile device and/or the server can confirm that the contactless card is is associated with the user account. For example, in some embodiments, the processor of the mobile device and/or the server can verify the cryptogram, identify the user account, and/or confirm that the contactless card is associated with the user account. In some embodiments, the processor of the mobile device and/or the server can successfully decrypt the cryptogram to verify the cryptogram and/or to identify the user account. For example, the processor of the mobile device and/or the server can decrypt protected data in the cryptogram, compare the protected data to record data associated with the contactless card and stored on the mobile device and/or the server, and identify the user account based on a match between the protected data and the record data. In embodiments in which the server verifies the cryptogram and/or identifies the user account, an interface of the mobile device can transmit the cryptogram to the server and receive one or more indications that the cryptogram has been verified, that the user account has been identified, and/or that the contactless card has been confirmed as being associated with the user account. For example, the mobile device can transmit one or more data messages to the server that include the cryptogram and can receive one or more indication messages that include an identification of the user account and/or an indication that the cryptogram has been verified and/or that the contactless card is associated with the user account.

After the cryptogram has been verified, the user account has been identified, and the contactless card has been confirmed as being associated with the user account as in 1306, the method 1300 can include verifying that a phone number of the mobile device is associated with the user account as in 1308. For example, the processor of the mobile device and/or the server can identify the phone number of the mobile device and compare the phone number of the mobile device to a recorded number associated with the user account and stored on the mobile device and/or the server to determine whether there is a match therebetween to verify that the phone number of the mobile device is associated with the user account. In some embodiments, the interface of the mobile device and/or the server can call or otherwise contact or connect with a mobile network operator to verify that the phone number of the mobile device matches mobile network operator data. In embodiments in which the server verifies that the phone number of the mobile device is associated with the user account, the interface of the mobile device can transmit identifying data to the server and can receive the recorded number associated with the user account and/or one or more indications that the phone number of the mobile device has been verified as being associated with the user account.

After the cryptogram has been verified, the user account has been identified, and both the contactless card and the phone number of the mobile device have been confirmed and verified as being associated with the user account as in 1308, the method 1300 can include authorizing execution of the digital transaction in connection with the user account as in 1310. For example, the processor of the mobile device and/or the server can authorize execution of the digital transaction. In some embodiments, the interface of the mobile device and/or the server can transmit one or more messages indicating that all security measures have been satisfied to execute the digital transaction in connection with the user account. Additionally or alternatively, in some embodiments, the interface of the mobile device and/or the server can transmit one or more messages with instructions to execute the digital transaction in connection with the user account.

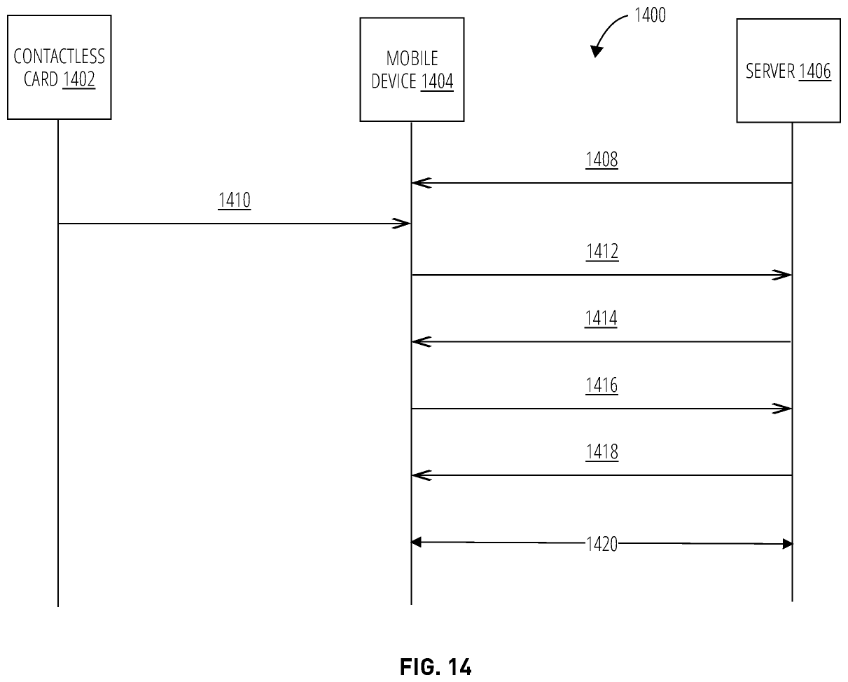

FIG. 14 illustrates an example of a sequence flow 1400 in accordance with disclosed embodiments. In some embodiments, verification and/or authentication can be performed by a mobile device 1404. Additionally or alternatively, in some embodiments, verification and/or authentication can be performed by a server 1406.

A digital transaction can be initiated in connection with a user account via an Internet browser on a desktop computer or the mobile device 1404 or via a mobile application on the mobile device 1404. The server 1406 can be in communication with the desktop computer and/or the mobile device 1404. As such, regardless of where the digital transaction initiated, the server 1406 can determine whether the digital transaction satisfies at least one predetermined risk factor. At 1408, the server 1406 can solicit communication between a contactless card 1402 and the mobile device 1404 when the digital transaction satisfies the at least one predetermined risk factor. Line 1408 can represent communication between the server 1406 and the mobile device 1404 and can include instructions to launch the mobile application and/or to display or emit a solicitation for the communication between the contactless card 1402 and the mobile device 1404. In some embodiments, the server 1406 can transmit the instructions to display or emit the solicitation for the communication between the contactless card 1402 and the mobile device 1404 to the desktop computer in addition to or in lieu of transmitting such instructions to the mobile device 1404.

At 1410, the contactless card 1402 can be tapped on or brought within a communication range of the mobile device 1404 and can exchange information with the mobile device 1404. Line 1410 can represent communication between the contactless card 1402 and the mobile device 1404 and can include a cryptogram stored on the contactless card 1402 and provided to the mobile device 1404. In some embodiments, protected data in the cryptogram can be encrypted using systems and methods described herein, for example, as discussed in FIGS. 1-10.

In some embodiments, communications between the contactless card 1402 and the mobile device 1404 can include NFC communications in accordance with one or more NFC protocols. However, embodiments disclosed herein are not so limited and can include other wireless technologies in addition to NFC or as an alternative to NFC, such as other short-range communication protocols.

The mobile device 1404 can process the cryptogram received from the contactless card 1402. For example, in some embodiments, the mobile device 1404 and/or the server 1406 can verify the cryptogram to identify the user account and to confirm that the contactless card 1402 is associated with the user account. In some embodiments, the mobile device 1404 can operate as a pass-through and transmit the cryptogram and other data to the server 1406 for verification and authentication thereof, for example, as discussed in FIGS. 1-10.

As seen in FIG. 14, at 1412, the mobile device 1404 can transmit information to the server 1406, and at 1414, the server 1406 can transmit information to the mobile device 1404. Line 1412 can represent communication from the mobile device 1404 to the server 1406, and line 1414 can represent communication from the server 1406 to the mobile device 1404. For example, in some embodiments, the mobile device 1404 can transmit the cryptogram received from the contactless card 1402 to the server 1406, as received, and the server 1406 can transmit to the mobile device 1404 an indication that the cryptogram has been verified, that the user account has been identified, and/or that the contactless card 1402 has been confirmed as being associated with the user account. However, in some embodiments, the mobile device 1404 can process the cryptogram received from the contactless card 1402, either partially or fully, and transmit the cryptogram to the server 1406, as processed, for example, protected data or keys either partially or fully decrypted. Additionally or alternatively, in some embodiments, the mobile device 1404 can transmit an information request to the server 1406 soliciting data stored on the server 1406, such as record data, for comparison to the protected data in the cryptogram received from the contactless card 1402, and the server 1406 can transmit such requested data to the mobile device 1404. Additionally or alternatively, in some some embodiments, the information request transmitted from the mobile device 1404 to the server can solicit an identification of the user account associated with the contactless card 1402 and/or data associated therewith, and the server 1406 can transmit such requested data to the mobile device 1404. In some embodiments, the mobile device 1404 can store the record data thereon for comparison to the protected data and/or can store the identification of the user account and/or the data associated therewith for comparison with data associated with the mobile device 1404, including a phone number of the mobile device 1404.

The mobile device 1404 and/or the server 1406 can also verify that the phone number of the mobile device 1404 is associated with the user account. As seen in FIG. 14, at 1416, the mobile device 1404 can transmit information to the server 1406, and at 1418, the server 1406 can transmit information to the mobile device 1404. Line 1416 can represent communication from the mobile device 1404 to the server 1406, and line 1418 can represent communication from the server 1406 to the mobile device 1404. For example, in some embodiments, the mobile device 1404 can transmit the phone number of the mobile device 1404 to the server 1406, and the server 1406 can transmit to the mobile device 1404 an indication that the phone number of the mobile device 1404 is associated with the user account. Additionally or alternatively, in some embodiments, the mobile device 1404 and/or the server 1406 can call or otherwise contact or connect with a mobile network operator to to verify that the phone number of the mobile device matches mobile network operator data. Additionally or alternatively, in some embodiments, the mobile device 1404 can transmit an information request to the server 1406 soliciting data stored on, retrieved by, or identified by the server 1406, such as a recorded number, for comparison to the phone number of the mobile device, and the server 1406 can transmit such requested data to the mobile device 1404. In some embodiments, the mobile device 1404 can store the recorded number thereon for comparison to the phone number of the mobile device 1404.

It is to be understood that the server 1406 can process any data, information, and/or requests received from the mobile device 1404 either partially or fully. For example, in some embodiments, the server 1406 can decrypt the cryptogram. Additionally or alternatively, in some embodiments, the server 1406 can compare received, processed, or retrieved data to data stored thereon for identification of additional data and/or for identification of matches therebetween.

It is also to be understood that the mobile device 1404 can communicate with the server 1406 via one or more wireless and/or wired connections. For example, in some embodiments, the mobile device 1404 can transmit any data, information, or requests to one or more application program interfaces (APIs) hosted by the server 1406. Additionally or alternatively, in some embodiments, the mobile device 1404 can transmit any data, information, or requests to one or more APIs hosted by a third party, such as a cloud-computing provider.

At 1420, upon verifying the cryptogram, identifying the user account, and confirming and/or verifying that both the contactless card and the phone number of the mobile device are associated with the user account, the mobile device 1404 and/or the server 1406 can authorize execution of the digital transaction in connection with the user account. As seen, at 1420, the mobile device 1404 and/or the server 1406 can communicate information therebetween to authorize the execution of the digital transaction in connection with the user account. Line 1420 can represent communication between the mobile device 1404 and the server 1406. For example, in some embodiments, mobile device 1404 and/or the server 1406 can transmit one or more messages and/or instructions to authorize the execution of the digital transaction in connection with the user account. In some embodiments, the server 1406 can transmit communication, messages, and/or instructions to one or more other devices, such as a third party server, etc., in addition to or in lieu of communication with the mobile device 1404 to authorize the execution of the digital transaction in connection with the user account.

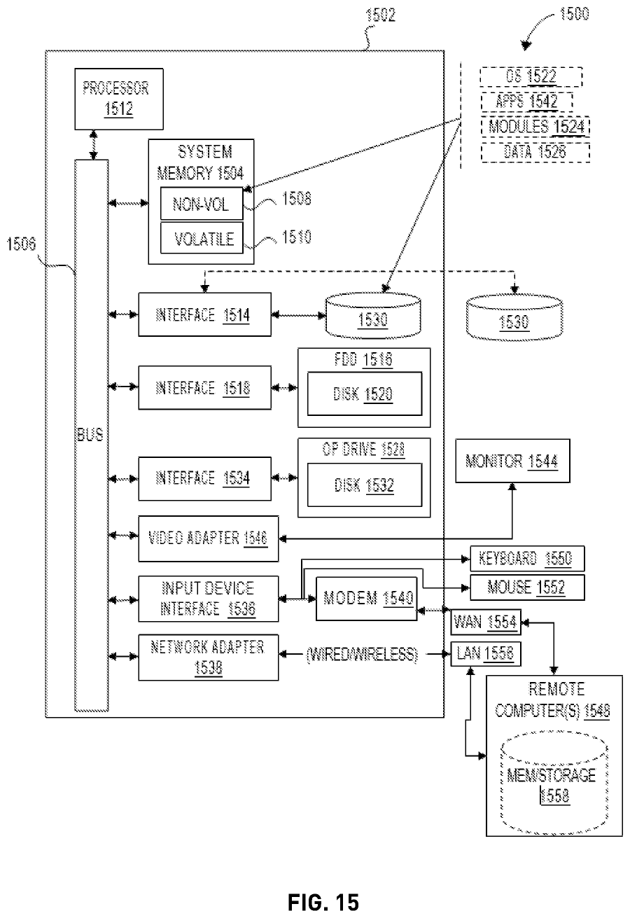

FIG. 15 illustrates an embodiment of an exemplary computer architecture 1500 suitable for implementing various embodiments as previously described. In one embodiment, the computer architecture 1500 may include or be implemented as part of one or more systems or devices discussed herein.

As used in this application, the terms “system” and “component” are intended to refer to a computer-related entity, either hardware, a combination of hardware and software, software, or software in execution, examples of which are provided by the exemplary computing computer architecture 1500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1500.

As shown in FIG. 15, the computing architecture 1500 includes a processor 1512, a system memory 1504 and a system bus 1506. The processor 1512 can be any of various commercially available processors.

The system bus 1506 provides an interface for system components including, but not limited to, the system memory 1504 to the processor 1512. The system bus 1506 can be any of several types of bus structure that may further interconnect to a memory bus (with or without a memory controller), a peripheral bus, and a local bus using any of a variety of commercially available bus architectures. Interface adapters may connect to the system bus 1506 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), Peripheral Component Interconnect (PCI) Express, Personal Computer Memory Card International Association (PCMCIA), and the like.

The computing architecture 1500 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1504 may include various types of computer-readable storage media in the form of one or more higher speed memory units, such as ROM, RAM, dynamic RAM (DRAM), Double-Data-Rate DRAM (DDRAM), synchronous DRAM (SDRAM), static RAM (SRAM), programmable ROM (PROM), EPROM, electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 15, the system memory 1504 can include non-volatile 1508 and/or volatile 1510. A basic input/output system (BIOS) can be stored in the non-volatile 1508.

A computer 1502 may include various types of computer-readable storage media in the form of one or more lower speed memory units, including an internal (or external) hard disk drive 1530, a magnetic disk drive 1516 to read from or write to a removable magnetic disk 1520, and an optical disk drive 1528 to read from or write to a removable optical disk 1532 (e.g., a CD-ROM or DVD). The hard disk drive 1530, magnetic disk drive 1516 and optical disk drive 1528 can be connected to system bus 1506 by a hard disk drive (HDD) interface 1514, and a floppy disk drive (FDD) interface 1518, and an optical disk drive interface 1534, respectively. The HDD interface 1514 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives, non-volatile 1508, and volatile 1510, including an operating system 1522, one or more applications 1542, other program modules 1524, and program data 1526. In one embodiment, the one or more applications 1542, other program modules 1524, and program data 1526 can include, for example, the various applications and/or components of the systems discussed herein.

A user can enter commands and information into the computer 1502 through one or more wire/wireless input devices, for example, a keyboard 1550 and a pointing device, such as a mouse 1552. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 1512 through an input device interface 1536 that is coupled to the system bus 1506 but can be connected by other interfaces such as a parallel port, IEEE 1394 serial port, a game port, a USB port, an IR interface, and so forth.

A monitor 1544 or other type of display device is also connected to the system bus 1506 via an interface, such as a video adapter 1546. The monitor 1544 may be internal or external to the computer 1502. In addition to the monitor 1544, a computer typically includes other peripheral output devices, such as speakers, printers, and so forth.

The computer 1502 may operate in a networked environment using logical connections via wire and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all the elements described relative to the computer 1502, although, for purposes of brevity, only a memory and/or storage device 1558 is illustrated. The logical connections depicted include wire/wireless connectivity to a local area network 1556 and/or larger networks, for example, a wide area network 1554. Such LAN and Wide Area Network (WAN) networking environments are commonplace in offices and companies, and facilitate enterprise-wide computer networks, such as intranets, all of which may connect to a global communications network, for example, the Internet.

When used in a local area network 1556 networking environment, the computer 1502 is connected to the local area network 1556 through a wire and/or wireless communication network interface or network adapter 1538. The network adapter 1538 can facilitate wire and/or wireless communications to the local area network 1556, which may also include a wireless access point disposed thereon for communicating with the wireless functionality of the network adapter 1538.

When used in a wide area network 1554 networking environment, the computer 1502 can include a modem 1540, or is connected to a communications server on the wide area network 1554 or has other means for establishing communications over the wide area network 1554, such as by way of the Internet. The modem 1540, which can be internal or external and a wire and/or wireless device, connects to the system bus 1506 via the input device interface 1536. In a networked environment, program modules depicted relative to the computer 1502, or portions thereof, can be stored in the remote memory and/or storage device 1558. It will be appreciated that the network connections shown are exemplary and other means of establishing a communications link between the computers can be used.

The computer 1502 can be operable to communicate with wired and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASICs), PLDs, DSPs, field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, ASICs, logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

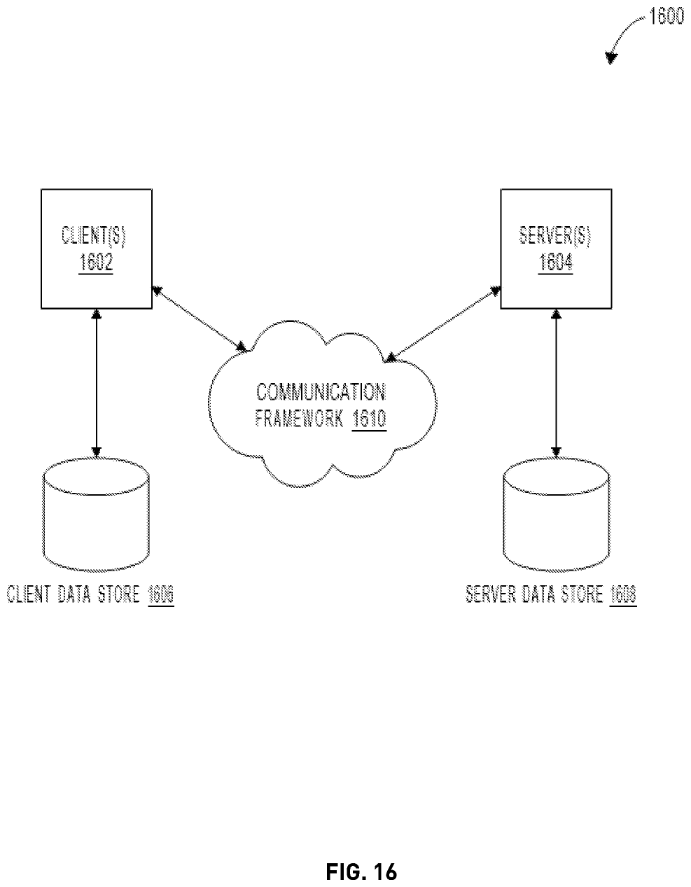

FIG. 16 is a block diagram depicting an exemplary communications architecture 1600 suitable for implementing various embodiments as previously described. The communications architecture 1600 includes various common communications elements, such as a transmitter, receiver, transceiver, radio, network interface, baseband processor, antenna, amplifiers, filters, power supplies, and so forth. The embodiments, however, are not limited to implementation by the communications architecture 1600, which may be consistent with systems and devices discussed herein.

As shown in FIG. 16, the communications architecture 1600 includes one or more client(s) 1602 and server(s) 1604. The server(s) 1604 may implement one or more functions and embodiments discussed herein. The client(s) 1602 and the server(s) 1604 are operatively connected to one or more respective client data store 1606 and server data store 1608 that can be employed to store information local to the respective client(s) 1602 and server(s) 1604, such as cookies and/or associated contextual information.

The client(s) 1602 and the server(s) 1604 may communicate information between each other using a communication framework 1610. The communication framework 1610 may implement any well-known communications techniques and protocols. The communication framework 1610 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1610 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by client(s) 1602 and the server(s) 1604. A communications network may be any one and the combination of wired and/or wireless networks including without limitation a direct interconnection, a secured custom connection, a private network (e.g., an enterprise intranet), a public network (e.g., the Internet), a PAN, a LAN, a Metropolitan Area Network (MAN), an Operating Missions as Nodes on the Internet (OMNI), a WAN, a wireless network, a cellular network, and other communications networks.

What is claimed is:

1. A method comprising:
when a digital transaction initiated in connection with a user account satisfies at least one predetermined risk factor, soliciting communication between a contactless card and a mobile device;
receiving, by a short-range communication antenna of the mobile device, a cryptogram from the contactless card;
verifying, by a processor of the mobile device, the cryptogram to identify the user account and to confirm that the contactless card is associated with the user account;
verifying, by the processor of the mobile device, that a phone number of the mobile device is associated with the user account; and
when the contactless card and the phone number of the mobile device are associated with the user account, authorizing execution of the digital transaction in connection with the user account.

2. The method of claim 1 wherein the digital transaction includes a wire transfer.

3. The method of claim 1 wherein the at least one predetermined risk factor includes the digital transaction being valued at a predetermined amount of currency or higher.

4. The method of claim 1 wherein the at least one predetermined risk factor includes the digital transaction originating from a suspicious location, a suspicious device, or a suspicious Internet Protocol (IP) address.

5. The method of claim 1 further comprising:
successfully decrypting the cryptogram to verify the cryptogram and identify the user account.

6. The method of claim 5 further comprising:
decrypting protected data in the cryptogram;
comparing the protected data to stored record data associated with the contactless card; and
identifying the user account based on a match between the protected data and the stored record data.

7. The method of claim 1 further comprising:
transmitting the cryptogram from the mobile device to a server; and
receiving, at the mobile device, one or more indications that the cryptogram and the phone number of the mobile device have been verified.

8. The method of claim 7 further comprising:
transmitting one or more messages from the mobile device to the server.

9. A non-transitory computer-readable medium comprising instructions that, when executed by a processor, cause the processor to:
solicit communication between a contactless card and a mobile device when a digital transaction initiated in connection with a user account satisfies at least one predetermined risk factor;
receive, via a short-range communication antenna of the mobile device, a cryptogram from the contactless card;
verify the cryptogram to identify the user account and to confirm that the contactless card is associated with the user account;
verify that a phone number of the mobile device is associated with the user account; and
when the contactless card and the phone number of the mobile device are associated with the user account, authorize execution of the digital transaction in connection with the user account.

10. The non-transitory computer-readable medium of claim 9 wherein the digital transaction includes a wire transfer.

11. The non-transitory computer-readable medium of claim 9 wherein the at least one predetermined risk factor includes the digital transaction being valued at a predetermined amount of currency or higher.

12. The non-transitory computer-readable medium of claim 9 wherein the at least one predetermined risk factor includes the digital transaction originating from a suspicious location, a suspicious device, or a suspicious IP address.

13. The non-transitory computer-readable medium of claim 9 wherein the instructions further cause the processor to successfully decrypt the cryptogram to verify the cryptogram and identify the user account.

14. The non-transitory computer-readable medium of claim 13 wherein the instructions further cause the processor to:
decrypt protected data in the cryptogram;
compare the protected data to stored record data associated with the contactless card; and
identify the user account based on a match between the protected data and the stored record data.

15. The non-transitory computer-readable medium of claim 13 wherein the instructions further cause the processor to:
transmit the cryptogram to a server; and
receive one or more indications that the cryptogram and the phone number of the mobile device have been verified.

16. The non-transitory computer-readable medium of claim 15 wherein the instructions further cause the processor to transmit one or more messages to the server.

17. A mobile device comprising:
a short-range communication antenna;
a processor; and
a memory storing instructions that, when executed by the processor, cause the processor to:
solicit communication with a contactless card when a digital transaction initiated in connection with a user account satisfies at least one predetermined risk factor;
receive, via the short-range communication antenna, a cryptogram from the contactless card;
verify the cryptogram to identify the user account and to confirm that the contactless card is associated with the user account;
verify that a phone number of the mobile device is associated with the user account; and
when the contactless card and the phone number of the mobile device are associated with the user account, authorize execution of the digital transaction in connection with the user account.

18. The mobile device of claim 17 further comprising:
a user interface device,
wherein the instructions further cause the processor to display on or emit from the user interface device a solicitation for the communication with the contactless card.

19. The mobile device of claim 17 further comprising:
an Internet browser or a mobile application,
wherein the digital transaction is initiated via the Internet browser or the mobile application.

20. The mobile device of claim 17 wherein the digital transaction is initiated via an Internet browser on a desktop computer.
